(19) United States
(12) Patent Application Publication
(10) Pub. No.: US 2026/0302121 A1
(43) Pub. Date: Oct. 1, 2026

(54) INLINE FUSE HOLDER FOR MULTIPLE FUSES

(71) Applicant: Suzhou Littelfuse OVS Co., Ltd., Suzhou (CN)

(72) Inventors: Shangchun Pan, Suzhou City (CN); Du Cheng, Suzhou (CN); Renan Liu, Suzhou (CN)

(73) Assignee: Suzhou Littelfuse OVS Co., Ltd., Suzhou (CN)

(21) Appl. No.: 19/630,605

(22) Filed: Mar. 27, 2026

(30) Foreign Application Priority Data
Mar. 31, 2025 (CN) 202510390408.2

(51) Int. Cl. H01H 85/20

(52) U.S. Cl. CPC H01H 85/20; H01H 2085/207

(57) ABSTRACT

An inline fuse holder can be electrically connected to a single input line and first and second output lines. The inline fuse holder can hold two different fuses, each of which can be electrically connected to the single input line. However, a first of the two different fuses can be electrically connected to the first output line, and a second of the two different fuses can be electrically connected to the second output line. The inline fuse holder can split input current carried on the single input line between the two different fuses, which can function simultaneously while conducting separate output current on the first and second output lines.

### CROSS-REFERENCE TO CORRESPONDING APPLICATIONS

This application claims the benefit of priority to, Chinese Patent Application No. 202510390408.2, filed Mar. 31, 2025, entitled “INLINE FUSE HOLDER FOR MULTIPLE FUSES,” which application is incorporated herein by reference in its entirety.

### FIELD

The present disclosure generally relates to fuse holders. More particularly, the present disclosure relates to an inline fuse holder for multiple fuses

### BACKGROUND

Inline fuse holders that hold a fuse between an input line and an output line are known in the art. However, known inline fuse holders can only hold a single fuse between a single input line and a single output line.

In view of the above, there is a continuing, ongoing need for improved inline fuse holders

### BRIEF SUMMARY

In some embodiments, an inline fuse holder can include an input adapter for electrically connecting with a single input line, a first fuse, and a second fuse, a first output adapter for electrically connecting with the first fuse and a first output line, and a second output adapter for electrically connecting with the second fuse and a second output line.

In some embodiments, the inline fuse holder can include a body housing the input adapter, the first output adapter, and the second output adapter.

In some embodiments, the input adapter can include a first input adapter terminal for electrically connecting with the single input line, a second input adapter terminal for electrically connecting with the first fuse, and a third input adapter terminal for electrically connecting with the second fuse.

In some embodiments, the second input adapter terminal and the third input adapter terminal can be the same type.

In some embodiments, the second input adapter terminal and the third input adapter terminal can be different types.

In some embodiments, the first output adapter can include a first first output adapter terminal for electrically connecting with the first fuse and a second first output adapter terminal for electrically connecting with the first output line, and the second output adapter can include a first second output adapter terminal for electrically connecting with the second fuse and a second second output adapter terminal for electrically connecting with the second output line.

In some embodiments, the input adapter is configured to evenly split current carried on the input line between the first fuse and the second fuse.

In some embodiments, an inline fuse holder can include a first input adapter for electrically connecting with a first single input line, a first fuse, and a second fuse, a first output adapter for electrically connecting with the first fuse and a first output line, a second output adapter for electrically connecting with the second fuse and a second output line, a second input adapter for electrically connecting with a second single input line, a third fuse, and a fourth fuse, a third output adapter for electrically connecting with the third fuse and a third output line, and a fourth output adapter for electrically connecting with the fourth fuse and a fourth output line.

In some embodiments, the inline fuse holder can include a body housing the first input adapter, the first output adapter, the second output adapter, the second input adapter, the third output adapter, and the fourth output adapter.

In some embodiments, the first input adapter can include a first first input adapter terminal for electrically connecting with the first single output line, a second first input adapter terminal for electrically connecting with the first fuse, and a third first input adapter terminal for electrically connecting with the second fuse, and the second input adapter can include a first second input adapter terminal for electrically connecting with the second single output line, a second second input adapter terminal for electrically connecting with the third fuse, and a third second input adapter terminal for electrically connecting with the fourth fuse.

In some embodiments, the second first input adapter terminal and the third first input adapter terminal can be the same type, and the second second input adapter terminal and the third second input adapter terminal can be the same type.

In some embodiments, the second first input adapter terminal and the third first input adapter terminal can be different types, and the second second input adapter terminal and the third second input adapter terminal can be different types.

In some embodiments, the second first input adapter terminal and the third first input adapter terminal can be the same type, and the second second input adapter terminal and the third second input adapter terminal can be different types.

In some embodiments, the first output adapter can include a first first output adapter terminal for electrically connecting with the first fuse and a second first output adapter terminal for electrically connecting with the first output line, the second output adapter can include a first second output adapter terminal for electrically connecting with the second fuse and a second second output adapter terminal for electrically connecting with the second output line, the third output adapter can include a first third output adapter terminal for electrically connecting with the third fuse and a second third output adapter terminal for electrically connecting with the third output line, and the fourth output adapter can include a first fourth output adapter terminal for electrically connecting with the fourth fuse and a second fourth output adapter terminal for electrically connecting with the fourth output line.

In some embodiments, the first input adapter can be configured to evenly split current carried on the first input line between the first fuse and the second fuse, and the second input adapter can be configured to evenly split current carried on the second input line between the third fuse and the fourth fuse.

In some embodiments, the inline fuse holder can include a first dual core wire carrying the first output line and the second output line and a second dual core wire carrying the third output line and the fourth output line.

In some embodiments, a method can include receiving input current from a single input line, splitting the input current into first fuse current and second fuse current, conducting the first fuse current from the single input line to a first input terminal electrically connected to the single input line, from the first input terminal to a first fuse electrically connected to the first input terminal, from the first fuse to a first output terminal electrically connected to the first fuse when the first fuse is closed, and from the first output terminal to a first output line electrically connected to to the first output terminal, and conducting the second fuse current from the single input line to a second input terminal electrically connected to the single input line, from the second input terminal to a second fuse electrically connected to the second input terminal, from the second fuse to a second output terminal electrically connected to the second fuse when the second fuse is closed, and from the second output terminal to a second output line electrically connected to to the second output terminal.

In some embodiments, the method can include evenly splitting the input current into the first fuse current and the second fuse current.

In some embodiments, the method can include failing to conduct the first fuse current from the first fuse to the first output terminal when the first fuse is open and failing to conduct the second fuse current from the second fuse to the second output terminal when the second fuse is open.

In some embodiments, the first output line and the second output line can be carried in a dual core wire.

Other technical features may be readily apparent to one skilled in the art from the following figures, descriptions, and claims.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1A is a perspective view illustrating an inline fuse holder in accordance with disclosed embodiments.

FIG. 1B is a side view illustrating an inline fuse holder fully assembled with fuses therein in accordance with disclosed embodiments.

FIG. 2 is a side view illustrating an interior of an inline fuse holder in accordance with disclosed embodiments.

FIG. 3 is a side view illustrating an interior of an inline fuse holder in accordance with disclosed embodiments.

FIG. 4A is a perspective view illustrating an input adapter of an inline fuse holder in accordance with disclosed embodiments.

FIG. 4B is a perspective view illustrating an input terminal of an inline fuse holder in accordance with disclosed embodiments.

FIG. 4C is a side view illustrating an input adapter of an inline fuse holder in accordance with disclosed embodiments.

FIG. 5A is a perspective view illustrating an inline fuse holder fully assembled with fuses therein in accordance with disclosed embodiments.

FIG. 5B is a top view illustrating an inline fuse holder fully assembled with fuses therein in accordance with disclosed embodiments.

FIG. 5C is a side view illustrating an inline fuse holder fully assembled with fuses therein in accordance with disclosed embodiments.

FIG. 6 is a perspective view illustrating an interior of an inline fuse holder in accordance with disclosed embodiments.

FIG. 7 is a side view illustrating an interior of an inline fuse holder in accordance with disclosed embodiments.

FIG. 8 is a flow chart illustrating a method in accordance with disclosed embodiments.

### DETAILED DESCRIPTION

Exemplary embodiments of an inline fuse holder for multiple fuses in accordance with the present disclosure will now be described more fully hereinafter with reference made to the accompanying drawings. The inline fuse holder may, however, be embodied in many different forms and should not be construed as being limited to the embodiments set forth herein. Rather, these embodiments are provided so that this disclosure will convey certain exemplary aspects of the inline fuse holder to those skilled in the art.

In accordance with disclosed embodiments, an inline fuse holder can be electrically connected to one, single input and two outputs. The inline fuse holder can hold two different fuses, each of which can be electrically connected to the one, single input. However, a first of the two different fuses can be electrically connected to a first of the two outputs, and a second of the two different fuses can be electrically connected to a second of the two outputs. In this regard, the two fuses can function simultaneously.

In some embodiments, the two fuses can be the same type of fuse. For example, in some embodiments, both of the two fuses can be mini fuses, Class M fuses, or the like. However, in some embodiments, the two fuses can be different types of fuses. For example, in some embodiments, one of the two fuses can be a mini fuse, and one of the two fuses can be a Class M fuse. It is to be understood that embodiments disclosed herein are not so limited and that additional and alternative types of fuses come within the spirit and scope of disclosed embodiments.

The inline fuse holder as disclosed herein can include terminals that can be configured for electrically connecting with a single type of fuse or different types of fuses. For example, the inline fuse holder can include an input adapter with a first terminal for electrically connecting with a single input line, a second terminal for electrically connecting with a first fuse, and a third terminal for electrically connecting with a second fuse. When the inline fuse holder is configured for electrically connecting with a single type of fuse, the second terminal and the third terminal can be a single type of terminal, that is, can have the same design or have metal shaped, bent, or crimped in the same manner for connecting to the same type of fuse. However, when the inline fuse holder is configured for electrically connecting with different types of fuses, the second terminal and the third terminal can be different types of terminals, that is, can have different designs or have metal shaped, bent, or crimped in different manners for connecting to the different types of fuses.

In accordance with disclosed embodiments, the inline fuse holder as disclosed herein can also be electrically connected to two inputs and four outputs. In particular, the inline fuse holder can hold four different fuses, two of which can be electrically connected to a first input and two of which can be electrically connected to a second input. A first of the four different fuses can be electrically connected to a first of the four outputs, a second of the four different fuses can be electrically connected to a second of the four outputs, a third of the four different fuses can be electrically connected to a third of the four outputs, and a fourth of the four different fuses can be electrically connected to a fourth of the four outputs. As above, when the inline fuse holder is electrically connected to two inputs and four outputs, the four fuses can be the same type of fuse, or one or more of the four fuses can be different types of fuses.

In embodiments in which the inline fuse holder is electrically connected to two inputs and four outputs, some of the four outputs can be carried together. For example, a first two of the four outputs can be carried in one dual core wire with a single jacket. Additionally or alternatively, a second two of the four outputs can be carried in another dual core wire with a single jacket.

Also in embodiments in which the inline fuse holder is electrically connected to two inputs and four outputs, the two of the four fuses electrically connected to the second input can be spare fuses, for example, when the second input is null. However, when the second input carries current therein, the two of the four fuses connected thereto can activated for circuit protection.

It is to be understood that embodiments disclosed herein are not limited to those with two fuses, one input, and two outputs or to those with four fuses, two inputs, and four outputs. Instead, an inline fuse holder as disclosed herein can be designed, configured, and scaled for operation with any number of fuses, inputs, and outputs as would be known and understood by one of ordinary skill in the art. For example, when the inline fuse holder is designed and configured for operation with N number of fuses, the inline fuse holder can be electrically connected to N/2 inputs and N outputs.

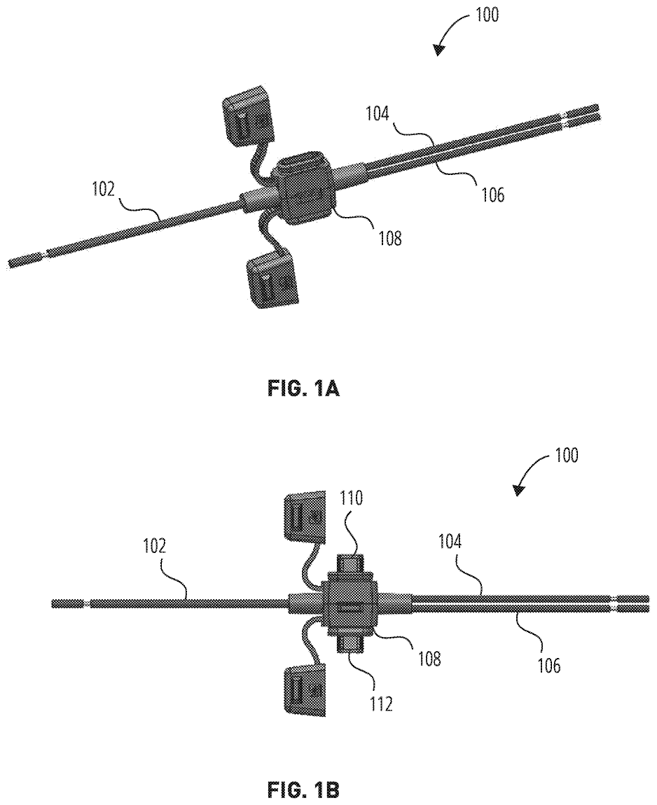

FIG. 1A is a perspective view illustrating an inline fuse holder 100 in accordance with disclosed embodiments, and FIG. 1B is a side view illustrating the inline fuse holder 100 fully assembled with first and second fuses 110, 112 therein in accordance with disclosed embodiments.

As seen, the inline fuse holder 100 can include a body 108 and be electrically connected to a single input line 102, a first output line 104, and a second output line 106. The body 108 can hold the first fuse 110, which can be electrically connected to the single input line 102 and the first output line 104. Similarly, the body 108 can hold the second fuse 112, which can be electrically connected to the single input line 102 and the second output line 106. In some embodiments, the body 108 can be over-molded as would be known and understood by one of ordinary skill in the art.

Although the body 108 is illustrated in FIG. 1A and FIG. 1B as holding the first fuse 110 on a top side thereof and holding the second fuse 112 on a bottom side thereof, embodiments disclosed herein are not so limited. Instead, the inline fuse holder 100, the body 108, and electrical connections housed therein can be configured in any manner as would be known and desired by one of ordinary skill in the art, for example, with the body 108 holding the first and second fuses 110, 112 on opposing sides thereof or with the body 108 holding the first and second fuses 110, 112 adjacent to one another, such as both on the top of the body 108, both on the bottom of the body 108, or both on the same side of the body 108.

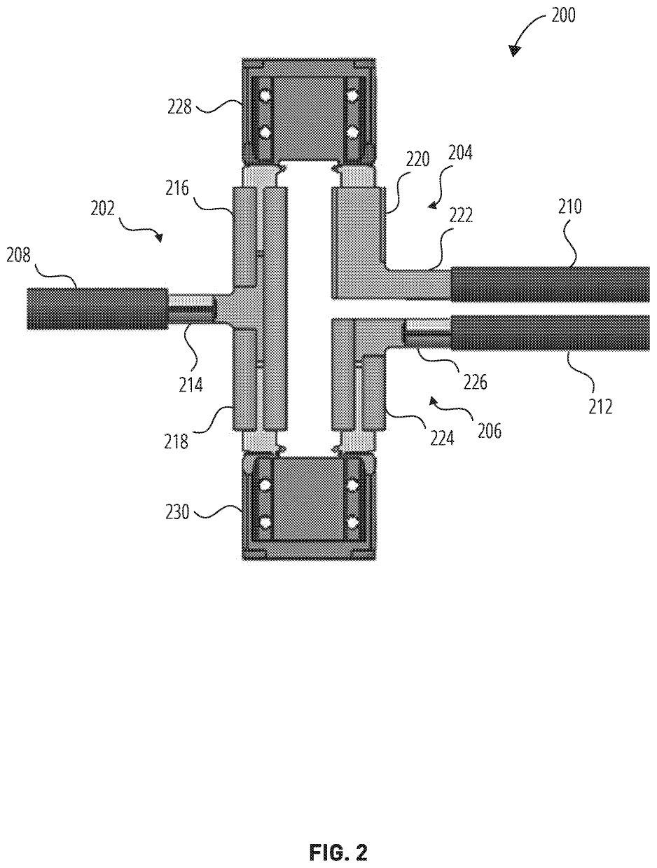

FIG. 2 is a side view illustrating an interior of an inline fuse holder 200 in accordance with disclosed embodiments. It is to be understood that the inline fuse holder 200 can be the same as or similar to the inline fuse holder 100.

As seen, the inline fuse holder 200 can include an input adapter 202, a first output adapter 204, and a second output adapter 206. In this regard, a body, such as the body 108, can house the input adapter 202, the first output adapter 204, and the second output adapter 206. The input adapter 202 can be configured for electrically connecting with a single input line 208, a first fuse 228, and a second fuse 230. Similarly, the first output adapter 204 can be configured for electrically connecting with the first fuse 228 and a first output line 210, and the second output adapter 206 can be configured for electrically connecting with the second fuse 230 and a second output line 212. The input adapter 202, the first output adapter 204, or the second output adapter 206 can be formed from copper alloy or any other metal as would be known and understood by one of ordinary skill in the art.

In some embodiments, the input adapter 202 can be configured to evenly split current carried on the input line 208 between the first fuse 228 and the second fuse 230. In particular, the input adapter 202 can include a first input adapter terminal 214 for electrically connecting with the single input line 208, a second input adapter terminal 216 for electrically connecting with the first fuse 228, and a third input adapter terminal 218 for electrically connecting with the second fuse 230. The current carried on the input line 208 can flow to the first input adapter terminal 214 and be split between the second input adapter terminal 216 and the third input adapter terminal 218, for example, via metal forming the input adapter 202 between the terminals 214, 216, 218, before flowing to the first fuse 228 and the second fuse 230, respectively. The terminals 214, 216, 218 can include terminals known and understood by one of ordinary skill in the art, including the metal of the input adapter 202 shaped, bent, or crimped for connecting with other components as disclosed herein.

In the embodiment disclosed in FIG. 2, the second input adapter terminal 216 and the third input adapter terminal 218 can be the same type. As such, the first fuse 228 and the second fuse 230 can be the same type.

As seen in FIG. 2, the input adapter 202 can be formed in a general T-shape. In particular, the second input adapter terminal 216 and the third input adapter terminal 218 can be co-linear, and the first input adapter terminal 214 can be perpendicular to the second input adapter terminal 216 and the third input adapter terminal 218. However, embodiments disclosed herein are not so limited. Instead, the input adapter 202 can be formed in any shape with the terminals 214, 216, 218 oriented relative to one another as would be known and understood by one or ordinary skill in the art.

The first output adapter 204 can include a first first output adapter terminal 220 for electrically connecting with the first fuse 228 and a second first output adapter terminal 222 for electrically connecting with the first output line 210. Current carried through the first fuse 228 can flow to the first first output adapter terminal 220 and through first output adapter 204, for example, via metal forming the first output adapter 204, to the second first output adapter terminal 222 and the first output line 210. The terminals 220, 222 can include terminals known and understood by one of ordinary skill in the art, including the metal of the first output adapter 204 shaped, bent, or crimped for connecting with other components as disclosed herein.

Similarly, the second output adapter 206 can include a first second output adapter terminal 224 for electrically connecting with the second fuse 230 and a second second output adapter terminal 226 for electrically connecting with the second output line 212. Current carried through the second fuse 230 can flow to the first second output adapter terminal 224 and through the second output adapter 206, for example, via metal forming the second output adapter 206, to the second second output adapter terminal 226 and the second output line 212. The terminals 224, 226 can include terminals known and understood by one of ordinary skill in the art, including the metal of the second output adapter 206 shaped, bent, or crimped for connecting with other components as disclosed herein.

As seen in FIG. 2, each of the first output adapter 204 and the second output adapter 206 can be formed in a general L-shape. In particular, the first first output adapter terminal 220 can be perpendicular with the second first output adapter terminal 222, and the first second output adapter terminal 224 can be perpendicular with the second second output adapter terminal 226. However, embodiments disclosed herein are not so limited. Instead, each of the first output adapter 204 and the second output adapter 206 can be formed in any shape with the terminals 220, 222 and the terminals 224, 226 oriented relative to one another as would be known and understood by one of ordinary skill in the art.

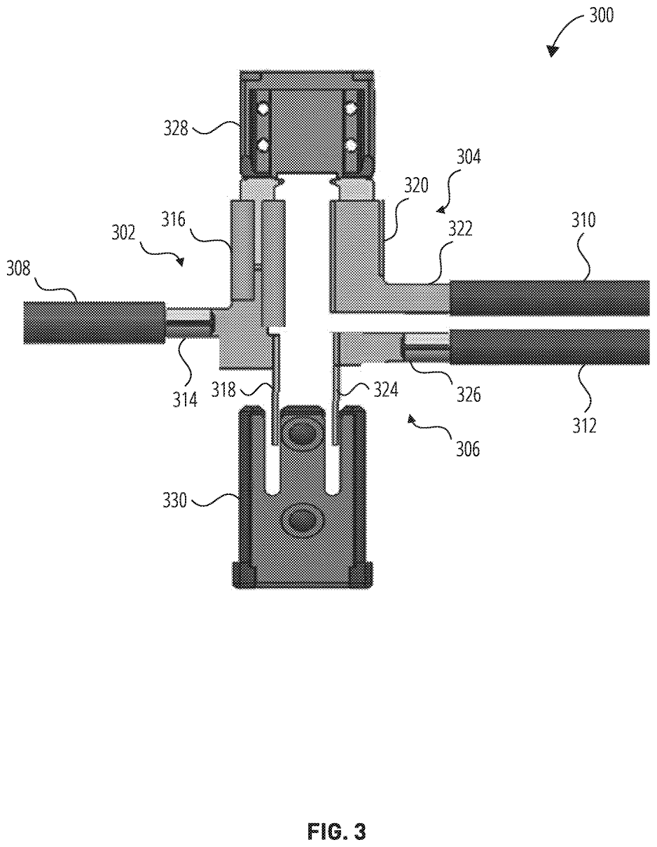

FIG. 3 is a side view illustrating an interior of an inline fuse holder 300 in accordance with disclosed embodiments. It is to be understood that the inline fuse holder 300 can be the same as or similar to the inline fuse holder 100.

As seen, the inline fuse holder 300 can include an input adapter 302, a first output adapter 304, and a second output adapter 306. In this regard, a body, such as the body 108, can house the input adapter 302, the first output adapter 304, and the second output adapter 306. The input adapter 302 can be configured for electrically connecting with a single input line 308, a first fuse 328, and a second fuse 330. Similarly, the first output adapter 304 can be configured for electrically connecting with the first fuse 328 and a first output line 310, and the second output adapter 306 can be configured for electrically connecting with the second fuse 330 and a second output line 312. The input adapter 302, the first output adapter 304, or the second output adapter 306 can be formed from copper alloy or any other metal as would be known and understood by one of ordinary skill in the art.

In some embodiments, the input adapter 302 can be configured to evenly split current carried on the input line 308 between the first fuse 328 and the second fuse 330. In particular, the input adapter 302 can include a first input adapter terminal 314 for electrically connecting with the single input line 308, a second input adapter terminal 316 for electrically connecting with the first fuse 328, and a third input adapter terminal 318 for electrically connecting with the second fuse 330. The current carried on the input line 308 can flow to the first input adapter terminal 314 and be split between the second input adapter terminal 316 and the third input adapter terminal 318, for example, via metal forming the input adapter 302 between the terminals 314, 316, 318, before flowing to the first fuse 328 and the second fuse 330, respectively. The terminals 314, 316, 318 can include terminals known and understood by one of ordinary skill in the art, including the metal of the input adapter 302 shaped, bent, or crimped for connecting with other components as disclosed herein.

In the embodiment disclosed in FIG. 2, the second input adapter terminal 316 and the third input adapter terminal 318 can be different types. As such, the first fuse 328 and the second fuse 330 can be different types.

As seen in FIG. 3, the input adapter 302 can be formed in a general T-shape. In particular, the second input adapter terminal 316 and the third input adapter terminal 318 can be co-linear, and the first input adapter terminal 314 can be perpendicular to the second input adapter terminal 316 and the third input adapter terminal 318. However, embodiments disclosed herein are not so limited. Instead, the input adapter 302 can be formed in any shape with the terminals 314, 316, 318 oriented relative to one another as would be known and understood by one or ordinary skill in the art.

The first output adapter 304 can include a first first output adapter terminal 320 for electrically connecting with the first fuse 328 and a second first output adapter terminal 322 for electrically connecting with the first output line 310. Current carried through the first fuse 328 can flow to the first first output adapter terminal 320 and through first output adapter 304, for example, via metal forming the first output adapter 304, to the second first output adapter terminal 322 and the first output line 310. The terminals 320, 322 can include terminals known and understood by one of ordinary skill in the art, including the metal of the first output adapter 304 shaped, bent, or crimped for connecting with other components as disclosed herein.

Similarly, the second output adapter 306 can include a first second output adapter terminal 324 for electrically connecting with the second fuse 330 and a second second output adapter terminal 326 for electrically connecting with the second output line 312. Current carried through the second fuse 330 can flow to the first second output adapter terminal 324 and through the second output adapter 306, for example, via metal forming the second output adapter 306, to the second second output adapter terminal 326 and the second output line 312. The terminals 324, 326 can include terminals known and understood by one of ordinary skill in the art, including the metal of the second output adapter 306 shaped, bent, or crimped for connecting with other components as disclosed herein.

As seen in FIG. 3, each of the first output adapter 304 and the second output adapter 306 can be formed in a general L-shape. In particular, the first first output adapter terminal 320 can be perpendicular with the second first output adapter terminal 322, and the first second output adapter terminal 324 can be perpendicular with the second second output adapter terminal 326. However, embodiments disclosed herein are not so limited. Instead, each of the first output adapter 304 and the second output adapter 306 can be formed in any shape with the terminals 320, 322 and the terminals 324, 326 oriented relative to one another as would be known and understood by one of ordinary skill in the art.

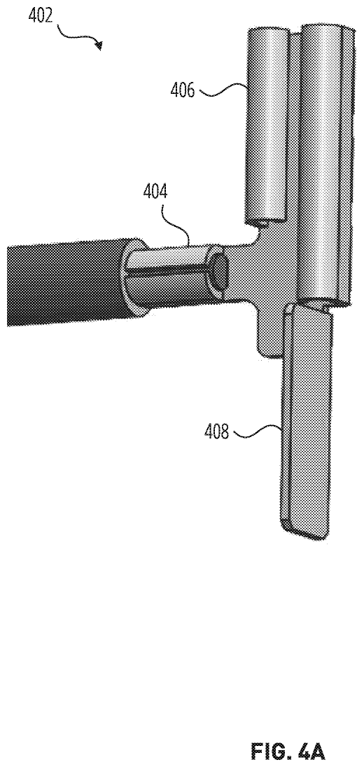

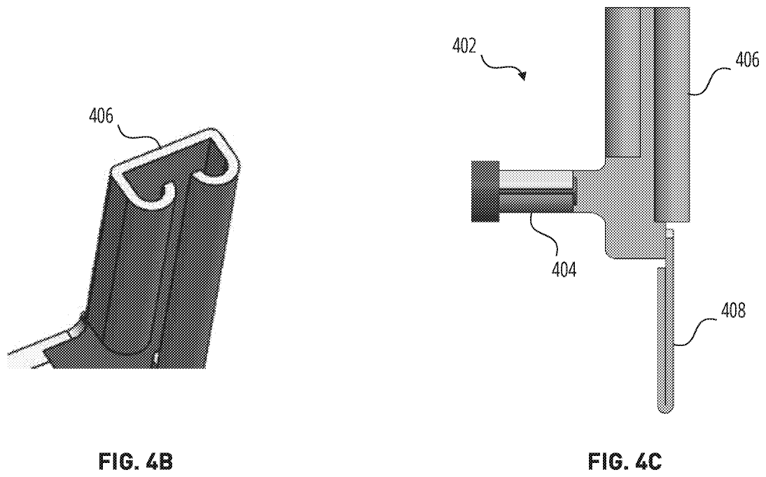

FIG. 4A is a perspective view illustrating an input adapter 402 of an inline fuse holder in accordance with disclosed embodiments. It is to be understood that the input adapter 402 can be the same as or similar to the input adapter 302.

As seen, the input adapter 402 can include a first input adapter terminal 404 for electrically connecting with a single input line, a second input adapter terminal 406 for electrically connecting with a first fuse, and a third input adapter terminal 408 for electrically connecting with a second fuse. When coupled with the single input line, the first fuse, and the second fuse, current carried on the single input line can flow to the first input adapter terminal 404 and be split between the second input adapter terminal 406 and the third input adapter terminal 408, for example, via metal forming the input adapter 402 between the terminals 404, 406, 408, before flowing to the first fuse and the second fuse, respectively.

In the embodiment disclosed in FIG. 4A, the second input adapter terminal 406 and the third input adapter terminal 408 can be different types. Regardless, the terminals 404, 406, 408 can include terminals known and understood by one of ordinary skill in the art, including the metal of the input adapter 402 shaped, bent, or crimped for connecting with other components as disclosed herein.

For example, as seen in FIG. 4B, the second input adapter terminal 406 can include ends of a flat surface of the metal of the input adapter 402 bent into first and second half circular shapes or C-shapes for holding the first fuse relative the flat surface when inserted in the input adapter 402.

However, as seen in FIG. 4A and FIG. 4C, the third input adapter terminal 408 can include a single layer of the flat surface of metal of the input adapter 402 (e.g., as in FIG. 4A) forming a blade or a double layer of the flat surface of the input adapter 402 (e.g., as in FIG. 4C) forming a blade, for example, with the flat surface folded over onto itself, for pressing against the second fuse when inserted in the input adapter 402. Different applications can necessitate single or double layers for blades of terminals.

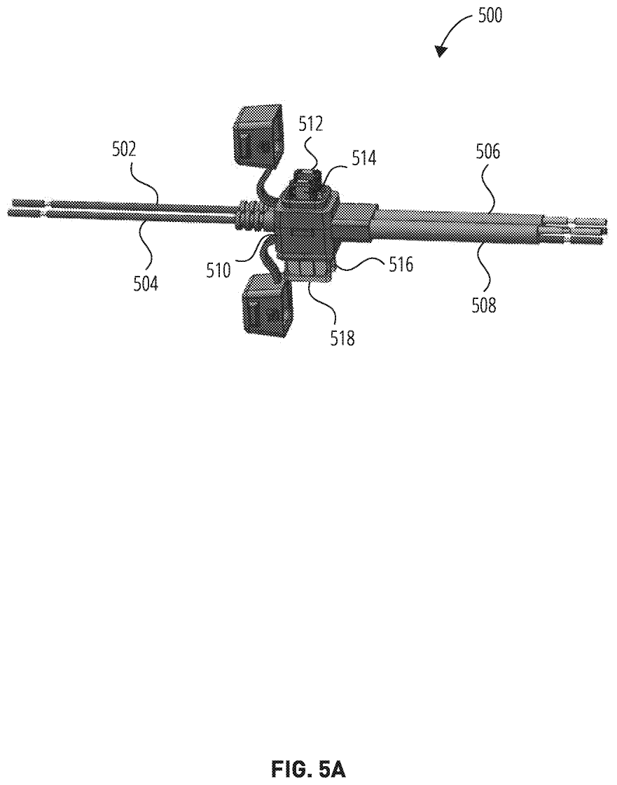

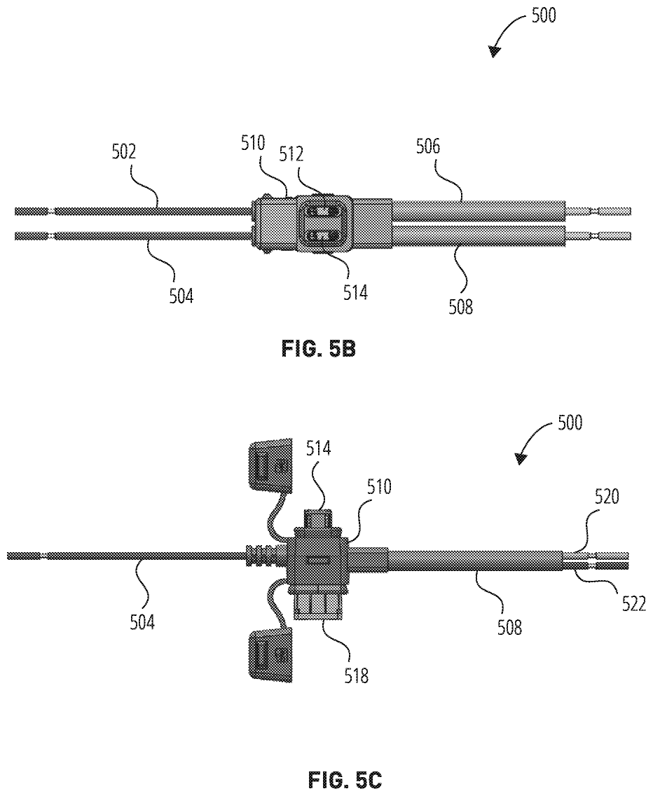

FIG. 5A is a perspective view illustrating an inline fuse holder 500 fully assembled with first, second, third, and fourth fuses 512, 514, 516, 518 therein in accordance with disclosed embodiments. Similarly, FIG. 5B is a top view illustrating the inline fuse holder 500 fully assembled with the first, second, third, and fourth fuses 512, 514, 516, 518 therein in accordance with disclosed embodiments, and FIG. 5C is a side view illustrating the inline fuse holder 500 fully assembled with the first, second, third, and fourth fuses 512, 514, 516, 518 therein in accordance with disclosed embodiments.

As seen, the inline fuse holder 500 can include a body 510 and be electrically connected to a first single input line 502, a second single input line 504, a first dual core wire 506, and a second dual core wire 508. Although not shown in the figures, it is to be understood that in some embodiments, the first single input line 502 and the second single input line 504 can be carried in an input dual core wire.

The body 510 can hold the first fuse 512, which can be electrically connected to the first single input line 502 and a first line of the first dual core wire 506. Similarly, the body 510 can hold the second fuse 514, which can be electrically connected to the second single input line 504 and a first line of the second dual core wire 508. The body 510 can also hold the third fuse 516, which can be electrically connected to the first single input line 502 and a second line of the first dual core wire 506, and the fourth fuse 518, which can be electrically connected to the second single input line 504 and a second line of the second dual core wire 508. In some embodiments, the body 510 can be over-molded as would be known and understood by one of ordinary skill in the art.

Although the body 510 is illustrated in FIG. 5A, FIG. 5B, and FIG. 5C as holding the first fuse 512 and the second fuse 514 on a top side thereof and holding the third fuse 516 and the fourth fuse 518 on a bottom side thereof, embodiments disclosed herein are not so limited. Instead, the inline fuse holder 500, the body 510, and electrical connections housed therein can be configured in any manner as would be known and desired by one of ordinary skill in the art, for example, with the body 510 holding the first and second fuses 512, 514 and/or the third and fourth fuses 516, 518 on opposing sides thereof or with the body 510 holding any combination of the first, second, third, and fourth fuses 512, 514, 516, 518 adjacent to one another, such as some or all on the top of the body 510, some or all on the bottom of the body 510, or some or all on the same side of the body 510.

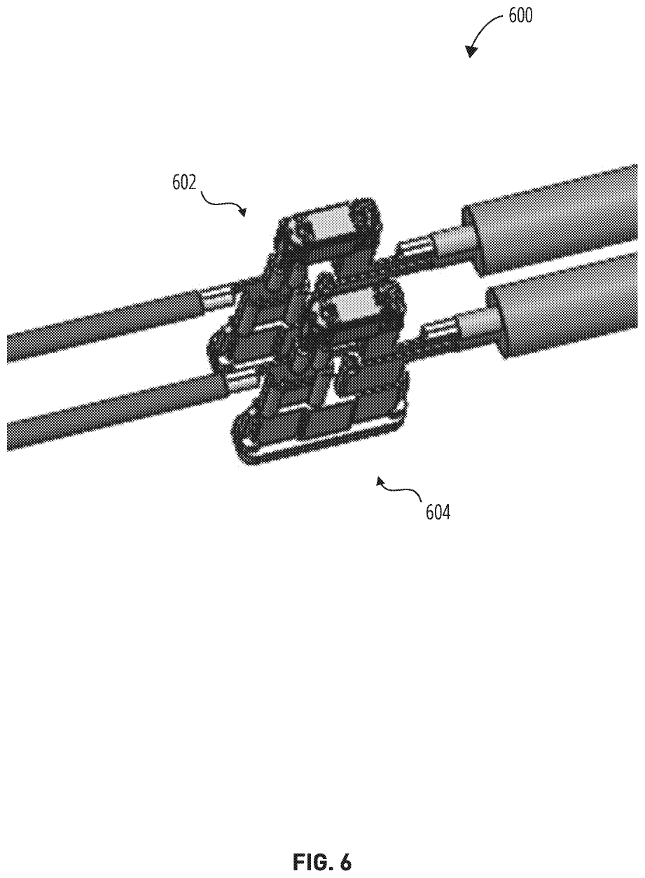

FIG. 6 is a perspective view illustrating an interior of an inline fuse holder 600 in accordance with disclosed embodiments. It is to be understood that the inline fuse holder 600 can be the same as or similar to the inline fuse holder 500.

As seen in FIG. 6, the inline fuse holder 600 an include a first inline fuse holder 602 and a second inline fuse holder 604. In this regard, a body, such as the body 510, can house the first inline fuse holder 602 and the second inline fuse holder 604.

As also seen in FIG. 6, the first inline fuse holder 602 and the second inline fuse holder 604 can sit alongside one another. However, embodiments disclosed herein are not so limited. Instead, the first inline fuse holder 602 and the second inline fuse holder 604 can be disposed end-to-end, top-to-bottom, or any other configuration relative to one another as would be known and understood by one of ordinary skill in the art.

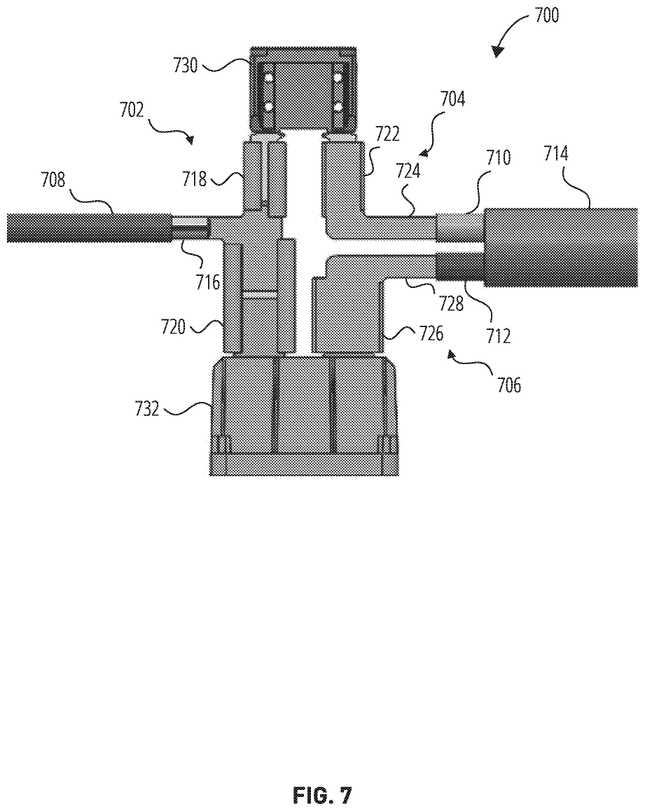

FIG. 7 is a side view illustrating an interior of an inline fuse holder 700 in accordance with disclosed embodiments. It is to be understood that the inline fuse holder 700 can be the same as or similar to the first inline fuse holder 602 or the second inline fuse holder 604.

As seen, the inline fuse holder 700 can include an input adapter 702, a first output adapter 704, and a second output adapter 706. In this regard, a body, such as the body 510, can house the input adapter 702, the first output adapter 704, and the second output adapter 706. The input adapter 702 can be configured for electrically connecting with a single input line 708, a first fuse 730, and a second fuse 732. Similarly, the first output adapter 704 can be configured for electrically connecting with the first fuse 730 and a first output line 710, and the second output adapter 706 can be configured for electrically connecting with the second fuse 732 and a second output line 712. In some embodiments, a dual core wire 714 can carry the first output line 710 and the second output line 712. The input adapter 702, the first output adapter 704, or the second output adapter 706 can be formed from copper alloy or any other metal as would be known and understood by one of ordinary skill in the art.

In some embodiments, the input adapter 702 can be configured to evenly split current carried on the input line 708 between the first fuse 730 and the second fuse 732. In particular, the input adapter 702 can include a first input adapter terminal 716 for electrically connecting with the single input line 708, a second input adapter terminal 718 for electrically connecting with the first fuse 730, and a third input adapter terminal 720 for electrically connecting with the second fuse 732. The current carried on the input line 708 can flow to the first input adapter terminal 716 and be split between the second input adapter terminal 718 and the third input adapter terminal 720, for example, via metal forming the input adapter 702 between the terminals 716, 718, 720, before flowing to the first fuse 730 and the second fuse 732, respectively. The terminals 716, 718, 720 can include terminals known and understood by one of ordinary skill in the art, including the metal of the input adapter 702 shaped, bent, or crimped for connecting with other components as disclosed herein.

In the embodiment disclosed in FIG. 7, the second input adapter terminal 718 and the third input adapter terminal 720 can be different types. As such, the first fuse 730 and the second fuse 732 can be different types. However, embodiments disclosed are not so limited. Instead, the second input adapter terminal 718 and the third input adapter terminal 720 can be the same type, thereby facilitating the first fuse 730 and the second fuse 732 being the same type.

As seen in FIG. 7, the input adapter 702 can be formed in a general T-shape. In particular, the second input adapter terminal 718 and the third input adapter terminal 720 can be co-linear, and the first input adapter terminal 716 can be perpendicular to the second input adapter terminal 718 and the third input adapter terminal 720. However, embodiments disclosed herein are not so limited. Instead, the input adapter 702 can be formed in any shape with the terminals 716, 718, 720 oriented relative to one another as would be known and understood by one or ordinary skill in the art.

The first output adapter 704 can include a first first output adapter terminal 722 for electrically connecting with the first fuse 730 and a second first output adapter terminal 724 for electrically connecting with the first output line 710. Current carried through the first fuse 730 can flow to the first first output adapter terminal 722 and through first output adapter 704, for example, via metal forming the first output adapter 704, to the second first output adapter terminal 724 and the first output line 710. The terminals 722, 724 can include terminals known and understood by one of ordinary skill in the art, including the metal of the first output adapter 704 shaped, bent, or crimped for connecting with other components as disclosed herein.

Similarly, the second output adapter 706 can include a first second output adapter terminal 726 for electrically connecting with the second fuse 732 and a second second output adapter terminal 728 for electrically connecting with the second output line 712. Current carried through the second fuse 732 can flow to the first second output adapter terminal 726 and through the second output adapter 706, for example, via metal forming the second output adapter 706, to the second second output adapter terminal 728 and the second output line 712. The terminals 726, 728 can include terminals known and understood by one of ordinary skill in the art, including the metal of the second output adapter 706 shaped, bent, or crimped for connecting with other components as disclosed herein.

As seen in FIG. 7, each of the first output adapter 704 and the second output adapter 706 can be formed in a general L-shape. In particular, the first first output adapter terminal 722 can be perpendicular with the second first output adapter terminal 724, and the first second output adapter terminal 726 can be perpendicular with the second second output adapter terminal 728. However, embodiments disclosed herein are not so limited. Instead, each of the first output adapter 704 and the second output adapter 706 can be formed in any shape with the terminals 722, 724 and the terminals 726, 728 oriented relative to one another as would be known and understood by one of ordinary skill in the art.

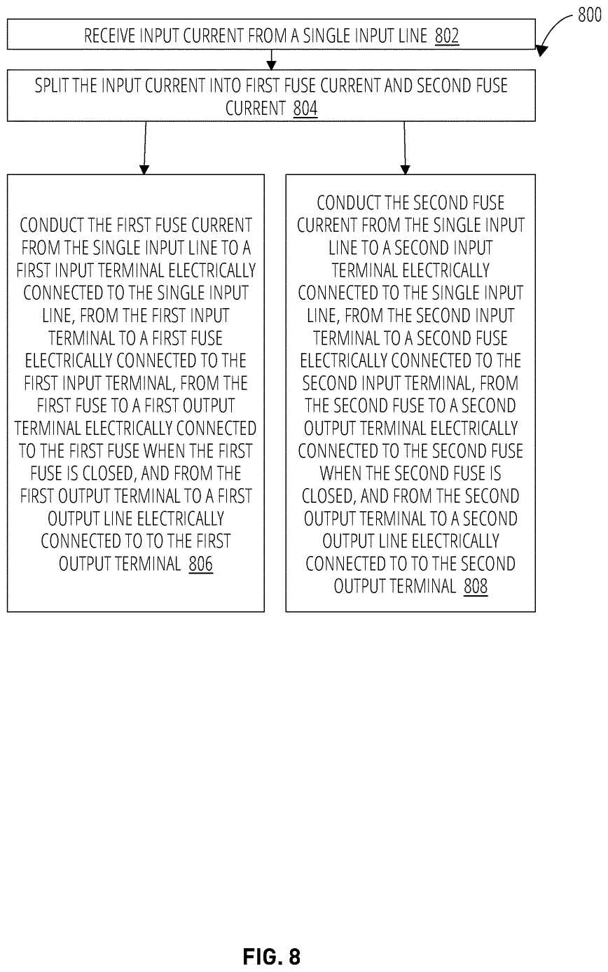

FIG. 8 is a flow chart illustrating a method 800 in accordance with disclosed embodiments. In some embodiments, the inline fuse holder 100, the inline fuse holder 200, the inline fuse holder 300, the inline fuse holder 500, the inline fuse holder 600, and/or the inline fuse holder 700 can execute some or all of the method 800.

As seen, the method 800 can include receiving input current from a single input line as in 802. Then, the method 800 can include splitting the input current into first fuse current and second fuse current as in 804. For example, in some embodiments, the method 800 can include evenly splitting the input current into the first fuse current and the second fuse current.

After splitting the input current as in 804, the method 500 can include conducting the first fuse current from the single input line to a first input terminal electrically connected to the single input line, from the first input terminal to a first fuse electrically connected to the first input terminal, from the first fuse to a first output terminal electrically connected to the first fuse when the first fuse is closed, and from the first output terminal to a first output line electrically connected to to the first output terminal as in 806. However, when the first fuse is open, for example, responsive to an overcurrent condition in the first fuse, the first fuse current can fail to conduct from the first fuse to the first output terminal.

Also after splitting the input current as in 804, the method 500 can include conducting the second fuse current from the single input line to a second input terminal electrically connected to the single input line, from the second input terminal to a second fuse electrically connected to the second input terminal, from the second fuse to a second output terminal electrically connected to the second fuse when the second fuse is closed, and from the second output terminal to a second output line electrically connected to to the second output terminal as in 808. However, when the second fuse is open, for example, responsive to an overcurrent condition in the second fuse, the second fuse current can fail to conduct from the second fuse to the second output terminal.

In some embodiments, the conducting as in 806 and the conducting as in 808 can be executed substantially simultaneously. Additionally or alternatively, in some embodiments, the first output line and the second output line can be carried in a dual core wire.

As used herein, an element or a step recited in the singular and proceeded with the word “a” or “an” should be understood as not excluding plural elements or steps, unless such exclusion is explicitly recited. Furthermore, references to “one embodiment” of the present disclosure are not intended to be interpreted as excluding the existence of additional embodiments that also incorporate the recited features.

While the present disclosure makes reference to certain embodiments, numerous modifications, alterations, and changes to the described embodiments are possible without departing from the sphere and scope of the present disclosure, as defined in the appended claims. Accordingly, it is intended that the present disclosure not be limited to the described embodiments, but that it has the full scope defined by the language of the following claims and equivalents thereof.

What is claimed is:

1. An inline fuse holder comprising:
an input adapter for electrically connecting with a single input line, a first fuse, and a second fuse;
a first output adapter for electrically connecting with the first fuse and a first output line; and
a second output adapter for electrically connecting with the second fuse and a second output line.

2. The inline fuse holder of claim 1 further comprising:
a body housing the input adapter, the first output adapter, and the second output adapter.

3. The inline fuse holder of claim 1 wherein the input adapter includes a first input adapter terminal for electrically connecting with the single input line, a second input adapter terminal for electrically connecting with the first fuse, and a third input adapter terminal for electrically connecting with the second fuse.

4. The inline fuse holder of claim 3 wherein the second input adapter terminal and the third input adapter terminal are the same type.

5. The inline fuse holder of claim 3 wherein the second input adapter terminal and the third input adapter terminal are different types.

6. The inline fuse holder of claim 1 wherein the first output adapter includes a first first output adapter terminal for electrically connecting with the first fuse and a second first output adapter terminal for electrically connecting with the first output line, and wherein the second output adapter includes a first second output adapter terminal for electrically connecting with the second fuse and a second second output adapter terminal for electrically connecting with the second output line.

7. The inline fuse holder of claim 1 wherein the input adapter is configured to evenly split current carried on the input line between the first fuse and the second fuse.

8. An inline fuse holder comprising:
a first input adapter for electrically connecting with a first single input line, a first fuse, and a second fuse;
a first output adapter for electrically connecting with the first fuse and a first output line;
a second output adapter for electrically connecting with the second fuse and a second output line;
a second input adapter for electrically connecting with a second single input line, a third fuse, and a fourth fuse;
a third output adapter for electrically connecting with the third fuse and a third output line; and
a fourth output adapter for electrically connecting with the fourth fuse and a fourth output line.

9. The inline fuse holder of claim 8 further comprising:
a body housing the first input adapter, the first output adapter, the second output adapter, the second input adapter, the third output adapter, and the fourth output adapter.

10. The inline fuse holder of claim 8 wherein the first input adapter includes a first first input adapter terminal for electrically connecting with the first single output line, a second first input adapter terminal for electrically connecting with the first fuse, and a third first input adapter terminal for electrically connecting with the second fuse, and wherein the second input adapter includes a first second input adapter terminal for electrically connecting with the second single output line, a second second input adapter terminal for electrically connecting with the third fuse, and a third second input adapter terminal for electrically connecting with the fourth fuse.

11. The inline fuse holder of claim 10 wherein the second first input adapter terminal and the third first input adapter terminal are the same type, and wherein the second second input adapter terminal and the third second input adapter terminal are the same type.

12. The inline fuse holder of claim 10 wherein the second first input adapter terminal and the third first input adapter terminal are different types, and wherein the second second input adapter terminal and the third second input adapter terminal are different types.

13. The inline fuse holder of claim 10 wherein the second first input adapter terminal and the third first input adapter terminal are the same type, and wherein the second second input adapter terminal and the third second input adapter terminal are different types.

14. The inline fuse holder of claim 10 wherein the first output adapter includes a first first output adapter terminal for electrically connecting with the first fuse and a second first output adapter terminal for electrically connecting with the first output line, wherein the second output adapter includes a first second output adapter terminal for electrically connecting with the second fuse and a second second output adapter terminal for electrically connecting with the second output line, wherein the third output adapter includes a first third output adapter terminal for electrically connecting with the third fuse and a second third output adapter terminal for electrically connecting with the third output line, and wherein the fourth output adapter includes a first fourth output adapter terminal for electrically connecting with the fourth fuse and a second fourth output adapter terminal for electrically connecting with the fourth output line.

15. The inline fuse holder of claim 8 wherein the first input adapter is configured to evenly split current carried on the first input line between the first fuse and the second fuse, and wherein the second input adapter is configured to evenly split current carried on the second input line between the third fuse and the fourth fuse.

16. The inline fuse holder of claim 8 further comprising:
a first dual core wire carrying the first output line and the second output line; and
a second dual core wire carrying the third output line and the fourth output line.

17. A method comprising:
receiving input current from a single input line;
splitting the input current into first fuse current and second fuse current;
conducting the first fuse current from the single input line to a first input terminal electrically connected to the single input line, from the first input terminal to a first fuse electrically connected to the first input terminal, from the first fuse to a first output terminal electrically connected to the first fuse when the first fuse is closed, and from the first output terminal to a first output line electrically connected to to the first output terminal; and
conducting the second fuse current from the single input line to a second input terminal electrically connected to the single input line, from the second input terminal to a second fuse electrically connected to the second input terminal, from the second fuse to a second output terminal electrically connected to the second fuse when the second fuse is closed, and from the second output terminal to a second output line electrically connected to to the second output terminal.

18. The method of claim 17 further comprising:
evenly splitting the input current into the first fuse current and the second fuse current.

19. The method of claim 17 further comprising:
failing to conduct the first fuse current from the first fuse to the first output terminal when the first fuse is open; and
failing to conduct the second fuse current from the second fuse to the second output terminal when the second fuse is open.

20. The method of claim 17 wherein the first output line and the second output line are carried in a dual core wire.
